(19) United States
(12) Patent Application Publication
(10) Pub. No.: US 2010/0320749 A1
(43) Pub. Date: Dec. 23, 2010

(54) Anchor system for pre-insulated piping

(76) Inventor: Thomas Joseph Keyes, Fort Worth, TX (US)

Correspondence Address: WHITAKER, CHALK, SWINDLE & SAWYER, LLP, 3500 CITY CENTER TOWER II, 301 COMMERCE STREET, FORT WORTH, TX, 76102-4186, US

(21) Appl. No.: 12/456,664

(22) Filed: Jun. 19, 2009

(51) Int. Cl. F16L 3/12; F16L 9/14; B23P 11/00

(52) U.S. Cl. 285/50; 138/106; 138/149; 29/455.1

(57) ABSTRACT

An anchor system is shown for use with a pre-insulated piping system having an inner steel carrier pipe surrounded by a layer of foam insulation and then by an outer protective jacket. The anchor system includes an inner carrier pipe for insertion within the length of the piping system at a selected point. A steel anchor sleeve surrounds a portion of the length of carrier pipe and foamed insulation. It terminates at one end at an outwardly flaring anchor plate which is subsequently embedded within a concrete anchor block. A steel end cap is welded to a second, opposite end of the sleeve and to the inner carrier pipe at a point along the length of piping which is outside the concrete anchor block and which is spaced apart from the location of the anchor plate, whereby heat from the high temperature fluids in the piping is transferred to the end cap at a location along the length of piping which is distant from the location of the anchor plate.

### BACKGROUND OF THE INVENTION

1. Field of the Invention

The present invention relates to pre-insulated piping systems, and more specifically to a method for anchoring a section of pre-insulated piping to prevent movement caused by thermal stresses in the pipeline or other environmental factors.

2. Description of the Prior Art

There are many instances in which insulated pipelines are needed. For example, distributed HVAC (heating, ventilation and air conditioning) applications utilize chilled water for cooling and steam for heating. The chiller and boiler are typically contained in a central location and the chilled water and steam are distributed to other locations. For example, on a school or college campus, the chiller and boiler may be located in a power plant building. The chilled water and steam are distributed to classrooms in separate buildings.

A set of insulated pipelines is used to convey the chilled water from the chiller to other locations and back to the chiller. Another set of insulated pipelines is used to carry the steam from the boiler to the other locations and back to the boiler. The insulated pipelines are usually located underground.

Pre-insulated pipe is conventional and commercially available. There are predominately two types of such piping systems in use: Class-A drainable dryable testable (DDT); and polyurethane or polyisocyanurate “bonded” foam systems. Both of these systems use an inner carrier pipe to convey fluid. Although steel is commonly used for the inner pipe which carries the media to be piped, copper or aluminum or other metals as well as fiberglass, PVC, and similar materials may be utilized, as well. Around the outside of the steel pipe is a layer of insulating foam such as, for example, polyisocyanurate foam. Around the outside of the foam is a jacket of hard thermoplastic (such as high density polyethylene, HDPE). The foam has set up or cured within the outer jacket so as to bond to the jacket and to the inner pipe. The plastic jacket protects the foam from mechanical damage and also provides a water tight seal to prevent corrosion of the steel pipe. In the bonded type system, the foam and outer jacket do not move relative to the inner pipe. In the Class-A type system, on the other hand, the insulated inner pipe is designed to move independently of the associated outer jacket. In fact, there is an air gap between the inner pipe and outer carrier pipe in the class-A type system.

There are various examples in the prior art of the need for “anchoring” such pre-insulated piping systems, either to guard against earth movement or to counteract thermal stresses in the pipe line itself. Also, anchors are generally needed at the entry ports of piping into, for instance, a concrete wall. The concrete wall might be a structural wall or foundation wall of a residential, commercial or industrial building or structure. Another common example is in the area of concrete manholes, valve pits and the like, in which conduits enter and leave the manhole through a sealed “porthole” or point of entry of the conduit into a sidewall or riser section of the manhole. It is generally necessary to anchor the pre-insulated pipeline at a point just prior to entry into the manhole since the sealed porthole does not generally allow for longitudinal movement of the piping.

Despite the advances which have been made in pre-insulated piping systems in recent years, and in particular to anchor points in such systems, a need continues to exist for further improvements.

For example, a need exists to better accommodate the high temperatures which are presently experienced at the location of the steel anchor plate which is used in such anchor assemblies, where the anchor plate contacts the steel carrier pipe and also contacts the surrounding foam insulation, particularly where the steel carrier pipe is carrying high temperature fluids.

A need also exists for such an anchor system which utilizes many of the conventionally available materials and manufacturing techniques commonly used in the industry and which is relatively simple in design and economical to implement.

### SUMMARY OF THE INVENTION

The present invention has as its object to provide an improved anchor installation for a pre-insulated piping system of the type used for conveying high temperature fluids. The particular type of piping system under consideration includes lengths of insulated and jacketed pre-insulated piping. The piping is made up of an inner carrier pipe having an interior surface and an exterior surface with an envelope of foamed insulation surrounding the inner pipe exterior surface. An outer protective jacket surrounds the envelope of insulation. The length of piping has a joining end for joining to an adjacent length of piping, whereby the adjacent lengths of piping provide a continuous length of fluid conduit for conveying high temperature fluids.

The anchor installation of the invention is located at a selected point along the length of the piping system and includes an inner metal carrier pipe for joining to the joining end of an adjacent length of piping in the piping system. The carrier pipe is surrounded by an envelope of foamed insulation. A special metal anchor sleeve surrounds at least a portion of the length of carrier pipe and foamed insulation. The anchor sleeve has a cylindrical length which terminates at a first end at an outwardly flaring anchor plate which is subsequently embedded within a concrete anchor block. The sleeve also has an opposite, second end. The sleeve is arranged to surround the envelope of foamed insulation in spaced apart relationship to the inner carrier pipe and extend outwardly from the concrete anchor block along the length of piping for a predetermined distance.

A metal end cap joins the anchor sleeve at the first end thereof to the inner carrier pipe at a point along the length of piping which is outside the concrete anchor block and which is spaced apart from the location of the anchor plate, whereby heat from the high temperature fluids in the piping is transferred to the end cap at a location along the length of piping which is distant from the location of the anchor plate.

The carrier pipe has an opposite end which extends from the anchor block in an opposite direction from the anchor sleeve. The opposite end of the carrier pipe is surrounded by a layer of foam insulation and then by an outer protective jacket. In one preferred form of the anchor assembly of the invention, the outer protective jacket is, in turn, surrounded by a watershed ring which is joined to the anchor plate at one extent and which is joined to the outer protective jacket at an opposite extent. In one preferred form, the watershed ring is formed of metal and the outer protective jacket is formed of a synthetic polyolefin material, the watershed ring being joined to the outer protective jacket by a heat shrink material.

Preferably, the foam insulation is selected from the group consisting of polyurethane foams and high temperature polyisocyanurate foams. The outer protective jacket is preferably a synthetic polyolefin, such as HDPE. The lengths of insulated piping can be part of a pipeline conveying steam, hot water or other hot fluids at a temperature above about 212° F.

Additional objects, features and advantages will be apparent in the written description which follows.

### BRIEF DESCRIPTION OF THE DRAWINGS

FIG. 1 is a simplified representation of a typical distributed HVAC system of the type under consideration which might utilize a high temperature fluid, such as steam, for heating.

FIG. 2 is a simplified view of an anchor installation of the present invention in a typical arrangement where the pipeline enters an underground valve pit.

FIG. 3 is a partial, sectional view of the anchor installation of the invention.

FIG. 4 is a view similar to FIG. 3, but showing the typical prior art anchor installation.

### DETAILED DESCRIPTION OF THE INVENTION

The preferred version of the invention presented in the following written description and the various features and advantageous details thereof are explained more fully with reference to the non-limiting examples included in the accompanying drawings and as detailed in the description which follows. Descriptions of well-known components and processes and manufacturing techniques are omitted so as to not unnecessarily obscure the principle features of the invention as described herein. The examples used in the description which follows are intended merely to facilitate an understanding of ways in which the invention may be practiced and to further enable those skilled in the art to practice the invention. Accordingly, the examples should not be construed as limiting the scope of the claimed invention.

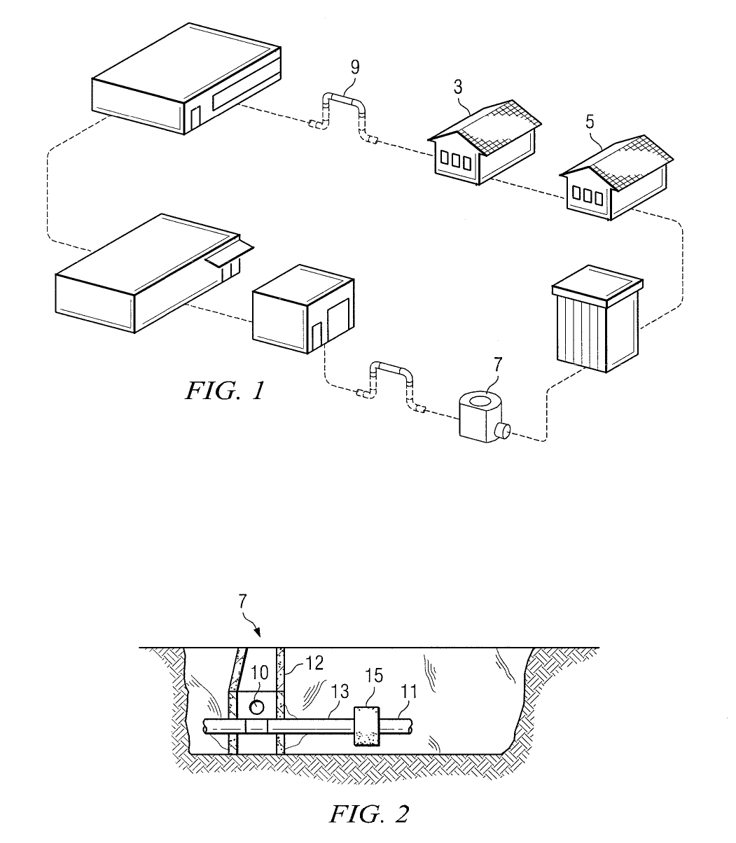

Turning first to FIGS. 1-2, there is illustrated a typical environment in which the pre-insulated piping systems of the invention might be employed. FIG. 1 shows a school campus having a number of isolated buildings 3, 5 connected by an underground insulated pipeline carrying steam which at points includes right angle loops or elbows 9. The loops 9 are provided in a typical piping system of the type illustrated in order to compensate for expansion and contraction forces which are exerted on the piping. The piping system will also typically include one or more manholes or “valve pits” 7. The valve pits 7 are typically formed of cast concrete and include portholes (10 in FIG. 2) and riser sections 12.

As will be appreciated by those skilled in the art, the anchor systems of the invention could be used with a variety of types of pipes and pipe installations. For sake of illustration, the principles of the invention will be described in relation to a concrete valve pit used in an insulated steam piping system. FIG. 2 is a somewhat simplified view of a portion of such an underground piping system of the type under consideration in which pipe sections 11 and 13 are located in generally parallel underground plane and which are intended to intersect previously located manhole or valve pit 7. The pipe sections 11, 13 are foam bonded pre-insulated piping sections, as that term is used in the relevant art. Each length of pipe includes an inner pipe, typically formed of steel, an envelope of foamed insulation surrounding the inner pipe, and outer protective jacket surrounding the envelope of insulation. The joining ends of the adjacent steel inner carrier pipe are affixed, as by being welded together, to form fixed joints, whereby the adjacent pipe lengths provide a continuous fluid conduit for conveying high temperature fluids. The inner foamed insulation will typically be of polyurethane or high temperature polyisocyanurate, while the outer protective jacket is typically formed of high density polyethylene (HDPE) or a similar polyolefin type material. The following references, among others, teach the manufacture of prior art insulated piping systems of the general type under consideration: U.S. Pat. No. 3,793,411; U.S. Pat. No. 4,084,842; and U.S. Pat. No. 4,221,405, all to Stonitsch et al.

The piping systems of the type illustrated in the drawings are typically utilized to convey fluids at high temperature and/or pressures. For example, a typical steam line might be conveying fluid at, for example, 400° F. The temperature differentials which exists between the piping system materials and the fluid being conveyed cause expansion and contraction forces to be applied along the coaxially aligned pipe lengths.

The expansion and contraction forces are partially compensated for in the prior art by including one or more expansion loops (illustrated at 9 in FIG. 1). However, it is also typically necessary to include one or more anchor installations (such as anchor installation 15 in FIG. 2) at various points along the length of piping. For example, it is typically necessary to install an anchor assembly just prior to the porthole openings (such as the porthole opening 10 in FIG. 2) of the concrete manhole, since the sealed portholes do not generally allow for longitudinal movement of the piping. This is primarily due to the fact that the piping is sealed at the point of entry into the manhole or valve pit.

For example, a Century Line Sleeve® can be cast into the wall of the concrete manhole at the porthole location. This commercially available product is a generally cylindrical sleeve formed of a polyolefin material, such as high density polyethylene, which lines the porthole in the wall of the concrete valve pit or manhole and which receives the section of the piping entering the interior of the manhole. A Link-Seal® is one type of sealing system is then used to form the seal between the piping and the Line Sleeve®. Both items are commercially available from Thunderline/Link-Seal of Houston, Tex. The Link-Seal® is a modular, mechanical type of seal, consisting of inter-locking synthetic rubber links shaped to continuously fill the annular space between the pipe and the wall opening containing the Line Sleeve®. The presence of these and other similar types of seal assemblies generally make it necessary to use a cast concrete anchor assembly in front of the porthole entry into the manhole or valve pit.

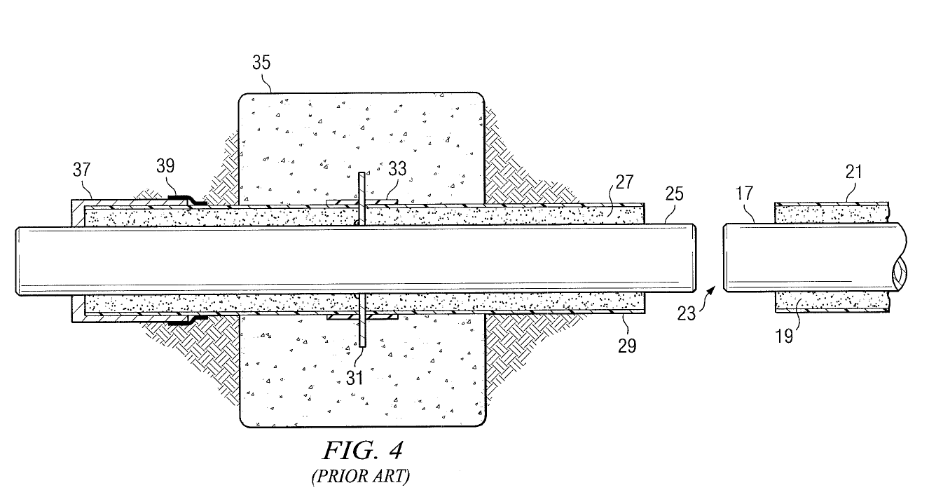

FIG. 4 is a partial cross-sectional view of a prior art anchor assembly of the type under consideration. The anchor system is used with a length of insulated and jacketed pre-insulated piping of the type having an inner carrier pipe 17 typically formed of a suitable metal, such as steel, and having an interior surface and an exterior surface. An envelope of foamed insulation 19 surrounds the inner pipe exterior surface and may comprise, for example the previously described high temperature polyisocyanurate. An outer protective jacket 21 surrounds the envelope of insulation. The outer protective jacket may be an HPDE material. The length of piping has a joining end 23 for joining to an adjacent length of piping, whereby the adjacent lengths of piping provide a continuous length of fluid conduit for conveying high temperature fluids.

Prior art pipe lengths of this general type are commercially available as standard factory type product. For example, such product is available from Thermacor Process, LP of Fort Worth, Tex., assignee of the present invention. One typical example is sold commercially as the “HT-406 High Temp Steel Piping System™.”

As will be appreciated, in the discussion which follows, the improved anchor systems of the invention can be used advantageously with the “HT-406 High Temp Steel Piping System™”. However, the anchor systems of the invention might also be used with other commercial piping systems used in the insulated pipe industries, as well. For example, the system of the invention could be used with Applicant's “Duo-Therm 505”™ system, of similar systems. In other words, the unique aspects of Applicant's systems may be used in a variety of applications requiring anchor installations. For example, the systems of the invention offer particular utility in situations where the insulated pipelines are subject to expansion and contraction forces which must be controlled at the point of entry into the building or structural sidewall or subterranean structure such as a valve pit or manhole.

The reference in this discussion to pipe “lengths” is intended to refer to standard available factory pre-insulated piping of the type previously described having an inner metal pipe surrounded by an envelope of foamed insulation, which in turn, is contained within a polyolefin jacket. As referred to briefly above, typical commercial practice involves the use of steel, copper, aluminum or alloy conveying pipes, open or closed cell polyurethane, polyisocyanurate, polystyrene or the like, foamed rigid insulation and polypropylene, polybutylene, polyethylene, polyvinylchloride and similar protective jackets.

The term “high temperature”, as used in this discussion, will be any temperature exceeding 250° F., which is the present temperature limitation at which polyurethane foam is used in bonded foam systems. Temperatures above 250° F. require the use of higher temperature foams, such as polyisocyanurate foam.

With reference again to the prior art anchor assembly shown in FIG. 4 of the drawings, it will be seen that the anchor assembly has an exposed joining end which includes a steel inner carrier pipe 25 surrounded by a layer of foam insulation 27, which is in turn surrounded by an outer protective jacket 29. An anchor plate 31 in the form of a radially outwardly extending disk is welded to the steel inner carrier pipe at a central location. The anchor plate will also typically be formed of steel. A steel ring 33 is welded to the anchor plate. A heat shrink tape is typically applied over the steel ring 33 in order to seal the ring to the HDPE jacket 29. The piping with its associated anchor plate and ring are embedded in a block of cast concrete 35. In the particular installation shown in FIG. 4, the opposite end of the carrier pipe is closed off with a steel end cap 37 and a layer of heat shrink material 39.

While anchor installations such as the one shown in FIG. 4 have been used commercially for many years, it will be appreciated that the direct connection between the anchor plate 31 and the inner steel carrier pipe creates a point of direct heat transfer for the high temperature fluids being carried by the inner carrier pipe. As a result, an undesirable “hot point” is created. This excessive heat can, in some instances, put a strain upon the corrosion coating which is conventionally applied to the anchor plate and also upon the heat shrink materials which are used in the anchor assembly.

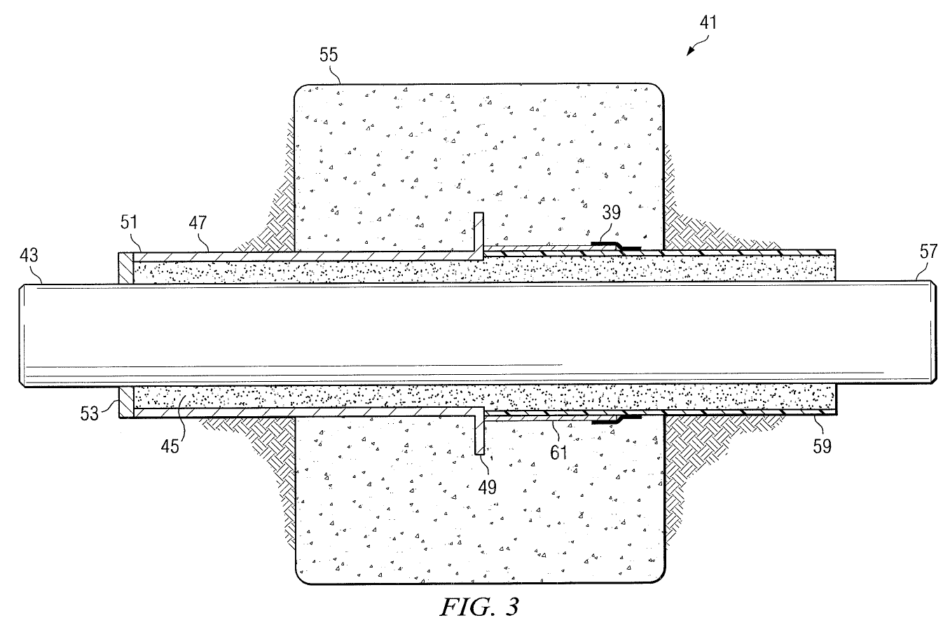

FIG. 3 illustrates the improved anchor installation of the invention. The anchor system of FIG. 3 is again intended to be used with a pre-insulated piping system of the type used for conveying high temperature fluids, such as that which has previously been described with respect to FIG. 4. In other words, the anchor assembly will be joined to a length of insulated and jacketed pre-insulated piping, where the piping has the components 17-23 previously described in FIG. 4.

The anchor installation of the invention is located at a selected point along the length of the piping system. The anchor installation (designated 41 in FIG. 3) includes an inner carrier pipe 43 for joining to the joining end of an adjacent length of piping in the piping system. The carrier pipe is surrounded by an envelope of foamed insulation 45. However, in the case of the anchor assembly of FIG. 3, the foam insulation has a special steel anchor sleeve 47 which surrounds at least a portion of the length of carrier pipe and foamed insulation. The anchor sleeve is comprised of a generally cylindrical steel conduit having a cylindrical length which terminates at a first end at an outwardly flaring anchor plate 49. The anchor plate 49 forms an outwardly extending flange surface with respect to the remainder of the exterior surface of the anchor sleeve 47. The anchor sleeve 47 also has an opposite, second end 51.

As will be appreciated from FIG. 3, the anchor sleeve 47 is arranged to surround the envelope of foamed insulation 45 in spaced apart relationship to the inner carrier pipe 43. In other words, the interior of the cylindrical length of the sleeve 47, as well as the terminating anchor plate 49 are spaced apart from the inner carrier pipe 43 along a majority of the length thereof, so that no heat transfer takes place.

As will also be appreciated from FIG. 3, the end 51 of the sleeve is closed off by means of a steel end cap 53 which is welded onto the carrier pipe 43 at the opposite end of the anchor sleeve 47 from the anchor plate 49. The end cap thus joins the anchor sleeve at the first end 51 thereof to the inner carrier pipe 43 at a point along the length of piping which is outside the subsequently poured concrete anchor block 55 and which is spaced apart from the location of the anchor plate 49, whereby heat from the high temperature fluids in the piping is transferred to the end cap 53 at a location along the length of piping which is distant from the location of the anchor plate 49. The end cap 53, in effect, forms a sort of “heat sink” for the anchor assembly.

As shown in FIG. 3, the carrier pipe 43 has an opposite end 57 which extends from the concrete anchor block 55 in an opposite direction from anchor sleeve 47. The opposite end 57 of the carrier pipe is surrounded by a layer of the foam insulation 45, and then by an outer protective jacket 59. The outer protective jacket is, in turn, surrounded by a metal watershed ring which is welded at one extent to the anchor plate 49. In order to provide a water proof enclosure, a layer of heat shrink material 61 is used to seal the watershed ring to the HDPE outer protective jacket 59. The “heat sink” provided by the improved assembly of the invention offers added protection for both the corrosion protective coating which is conventionally applied to the anchor plate, and to the heat shrink material used at the junction of the watershed ring and the outer HDPE jacket.

A method is also shown for installing an anchor in a section of pre-insulated piping of the type previously described. A first and second lengths of insulated and jacketed piping are provided, each having a joining end to be joined to an end of the other length, each pipe length comprising an inner metal pipe having an interior surface and an exterior surface. An envelope of foamed insulation is applied so that it surrounds the inner pipes exterior surface and envelopes the inner pipes. Thereafter, an outer protective jacket is applied which surrounds the envelope of insulation. The joining ends of adjacent pipe lengths are welded together to form fixed joints, whereby the adjacent pipe lengths provide a continuous fluid conduit for conveying high temperature fluids.

The anchor assembly of the invention is installed at a selected location within the length of the piping system. The anchor assembly has an inner carrier pipe for joining with ends of adjacent pipe lengths in the length of piping. The assembly includes an inner carrier pipe for joining to the joining end of an adjacent length of piping in the piping system, the carrier pipe being surrounded by an envelope of foamed insulation. The previously described special metal anchor sleeve is used to surround at least a portion of the length of carrier pipe and foamed insulation, where the metal anchor sleeve has a cylindrical length which terminates at a first end at an outwardly flaring anchor plate which is subsequently embedded within a concrete anchor block. The anchor sleeve is arranged to surround the envelope of foamed insulation in spaced apart relationship to the inner carrier pipe and extend outwardly from the concrete anchor block along the length of piping for a predetermined distance.

As previously described, a metal end cap is then used to join the anchor sleeve at the first end thereof to the inner carrier pipe at a point along the length of piping which is outside the concrete anchor block and which is spaced apart from the location of the anchor plate, whereby heat from the high temperature fluids in the piping is transferred to the end cap at a location along the length of piping which is distant from the location of the anchor plate.

An invention has been provided with several advantages. The improved anchor assembly of the invention provides an improved anchor point in pre-insulated piping systems of the type which are commercially available in the industry. The anchor system of the invention is better able to accommodate the high temperatures which are presently experienced at the location of the steel anchor plate in existing anchor systems, where the anchor plate contacts the steel carrier pipe, particularly where the steel carrier pipe is carrying high temperature fluids. Because of the presence of the special anchor sleeve used in the assembly of the invention, the effective heat transfer point between hot fluids in the carrier pipe and the surrounding materials is moved down the length of pipe from the location of the anchor plate. As a result, less strain is placed upon the conventional materials used to make up the anchor assembly. The anchor system of the invention utilizes many of the conventionally available materials and manufacturing techniques commonly used in the industry, and which is relatively simple in design and economical to implement.

While the invention has been shown in one of its forms, it is not thus limited but is susceptible to various changes and modifications without departing from the spirit thereof.

What is claimed is:

1. A pre-insulated piping system of the type used for conveying high temperature fluids, comprising:
a length of insulated and jacketed pre-insulated piping, the length of piping comprising an inner carrier pipe having an interior surface and an exterior surface, an envelope of foamed insulation surrounding the inner pipe exterior surface, and an outer protective jacket surrounding the envelope of insulation, the length of piping having a joining end for joining to an adjacent length of piping, whereby the adjacent lengths of piping provide a continuous length of fluid conduit for conveying high temperature fluids;
an anchor installation located at a selected point along the length of the piping system, the anchor installation including an inner carrier pipe for joining to the joining end of an adjacent length of piping in the piping system, the carrier pipe being surrounded by an envelope of foamed insulation, and wherein a special anchor sleeve surrounds at least a portion of the length of carrier pipe and foamed insulation, the anchor sleeve having a cylindrical length which terminates at a first end at an outwardly flaring anchor plate which is subsequently embedded within a concrete anchor block, the sleeve also having an opposite, second end, the sleeve being arranged to surround the envelope of foamed insulation in spaced apart relationship to the inner carrier pipe and extend outwardly from the concrete anchor block along the length of piping for a predetermined distance; and
an end cap which joins the anchor sleeve at the first end thereof to the inner carrier pipe at a point along the length of piping which is outside the concrete anchor block and which is spaced apart from the location of the anchor plate, whereby heat from the high temperature fluids in the piping is transferred to the end cap at a location along the length of piping which is distant from the location of the anchor plate.

2. The pre-insulated piping system of claim 1, wherein the carrier pipe has an opposite end which extends from the anchor block in an opposite direction from anchor sleeve, the opposite end of the carrier pipe being surrounded by a layer of foam insulation and then by an outer protective jacket, the outer protective jacket, in turn, being surrounded by a watershed ring which is joined to the anchor plate at one extent and which is joined to the outer protective jacket at an opposite extent.

3. The pre-insulated piping system of claim 2, wherein the watershed ring is formed of metal and the outer protective jacket is formed of a synthetic polyolefin material, and wherein the watershed ring is joined to the outer protective jacket by a heat shrink material.

4. The pre-insulated piping system of claim 3, wherein the foam insulation is selected from the group consisting of polyurethane foams and high temperature polyisocyanurate foams.

5. The pre-insulated piping system of claim 4, wherein the lengths of insulated piping are part of a pipeline conveying steam, hot water or other hot fluids at a temperature above about 212° F.

6. A method of installing an anchor in a section of pre-insulated piping, the method comprising the steps of:
providing a first and second length of insulated and jacketed pipe, each having a joining end to be joined to an end of the other length, each pipe length comprising an inner metal pipe having an interior surface and an exterior surface;
applying an envelope of foamed insulation which surrounds the inner pipes exterior surface and envelopes the inner pipes;
applying an outer protective jacket which surrounds the envelope of insulation, the joining ends of adjacent pipe lengths being welded together to form fixed joints, whereby the adjacent pipe lengths provide a continuous fluid conduit for conveying high temperature fluids;
installing an anchor assembly at a selected location within the length of the piping system, the anchor assembly having an inner carrier pipe for joining with ends of adjacent pipe lengths in the length of piping, including an inner carrier pipe for joining to the joining end of an adjacent length of piping in the piping system, the carrier pipe being surrounded by an envelope of foamed insulation, and wherein a special metal anchor sleeve is used to surround at least a portion of the length of carrier pipe and foamed insulation, the metal anchor sleeve having a cylindrical length which terminates at a first end at an outwardly flaring anchor plate which is subsequently embedded within a concrete anchor block, the sleeve also having an opposite, second end, the sleeve being arranged to surround the envelope of foamed insulation in spaced apart relationship to the inner carrier pipe and extend outwardly from the concrete anchor block along the length of piping for a predetermined distance; and
wherein a metal end cap is used to join the anchor sleeve at the first end thereof to the inner carrier pipe at a point along the length of piping which is outside the concrete anchor block and which is spaced apart from the location of the anchor plate, whereby heat from the high temperature fluids in the piping is transferred to the end cap at a location along the length of piping which is distant from the location of the anchor plate.

7. The method of claim 6, wherein the carrier pipe has an opposite end which extends from the anchor block in an opposite direction from anchor sleeve, the opposite end of the carrier pipe being surrounded by a layer of foam insulation and then by an outer protective jacket, the outer protective jacket, in turn, being surrounded by a watershed ring which is joined to the anchor plate at one extent and which is joined to the outer protective jacket at an opposite extent.

8. The method of claim 7, wherein the watershed ring is formed of metal and the outer protective jacket is formed of a synthetic polyolefin material, and wherein the watershed ring is joined to the outer protective jacket by a heat shrink material.

9. The method of claim 8, wherein the foam insulation is selected from the group consisting of polyurethane foams and high temperature polyisocyanurate foams.

10. The method of claim 9, wherein the lengths of insulated piping are part of a pipeline conveying steam, hot water or other hot fluids at a temperature above about 212° F.

11. The method of claim 10, wherein the length of insulated and jacketed piping which exits the concrete anchor block passes into the interior space of a valve pit.
